(19) United States
(12) Patent Application Publication
(10) Pub. No.: US 2016/0288597 A1
(43) Pub. Date: Oct. 6, 2016

(54) DEVICE FOR CONTROLLING THE PRESSURE IN A VEHICLE TYRE

(71) Applicant: PRESSURERITE (PTY) LTD, Cape Town (ZA)

(72) Inventor: Pierre Van Wyk BECKER, Cape Town (ZA)

(21) Appl. No.: 15/038,465

(22) PCT Filed: Nov. 20, 2014
(86) PCT No.: PCT/IB2014/066195

§ 371 Date: May 22, 2016

(30) Foreign Application Priority Data
Nov. 22, 2013 (ZA) 2013/08795

(51) Int. Cl. B60C 23/12; F16D 27/02; H05B 6/10; F04B 39/06; H05B 6/06; B60C 23/00; F16D 27/14

(52) U.S. Cl. CPC B60C 23/12; B60C 23/004; B60C 23/007; F16D 27/02; F16D 27/14; F04B 39/06; H05B 6/06; H05B 6/101

(57) ABSTRACT

A device (10) for providing air under pressure to a rotating pneumatic tyre is disclosed. The device comprises a pump (48, 50, 60) which in use rotates with the tyre and which provides air under pressure to the tyre when the pump is activated. There is a pump drive system for activating the pump upon a loss of pressure in the tyre. The pump drive system includes a connecting rod (54) which is rotationally connected to the tyre and an eccentric body (32) which rotates with the rod when the pump is inactive. The eccentric body is inhibited from rotating with the rod to activate the pump. Relative rotation between the rod and the eccentric body drives the pump to provide air under pressure to the tyre. An electromagnetic clutch is provided which has a first plate (26) which is non-rotatable and a rotor (38) which rotates with the body. The plate (26) carries magnets (42) and the rotor (38) carries coils (40). The first plate is connected to the second plate electromagnetically when the clutch is engaged to prevent rotation of the second plate and hence of the connecting rod. To heat the device it is operated either by supplying current to the coils of insufficient magnitude to engage the clutch but of sufficient magnitude to induce eddy current in the stator, or by short-circuiting the coils so that as they rotate in the magnetic field heating currents are induced in them.

### FIELD OF THE INVENTION

This invention relates to self-contained devices for maintaining pressure in rotating elements, such as vehicle tyres.

### BACKGROUND TO THE INVENTION

Devices for maintaining vehicle tyre pressure are disclosed in U.S. Specification U.S. Pat. No. 7,013,931 and PCT/IB2013/054732 (published as WO2014/009822). The devices are attached to vehicle wheels and each includes a hanging, stationary counterweight, while the remainder of the device normally rotates with the wheel. When a tyre on the vehicle wheel loses pressure, a part of the device becomes connected to the counterweight, so that it becomes stationary. Relative motion between the part that is stationary and the remainder of the device is used to drive a pump that pressurises the tyre to the desired pressure.

In co-pending PCT Application No. PCT/IB2014/066188 there is disclosed a device for providing air under pressure to a rotating pneumatic tyre. The device comprises a pump which in use rotates with the tyre and provides air to the tyre when it is activated. The drive system for activating the pump upon a loss of pressure in the tyre comprises a first part that is rotationally connected to the tyre and a second part that rotates with the first part when the pump is inactive and is inhibited from rotating with the first part to activate the pump. Relative rotation between the first and second parts drives the pump to provide air under pressure to the tyre. The device includes a first clutch plate which is non-rotatable and a second clutch plate which rotates with the second part of the pump drive system. One of the plates of the clutch carries coils.

Such a device will herein be referred to as “a device of the kind defined”.

### SUMMARY OF THE INVENTION

According to one aspect of the present invention there is provided a method of operating a device of the kind defined to heat the device which method includes the steps of rotating the clutch plates relatively to one another and supplying current to the coils which current generates a flux of insufficient magnitude to engage the clutch but of sufficient magnitude to generate eddy currents in the other clutch plate.

According to a further aspect of the present invention there is provided a method of operating a device of the kind defined, and in which the other clutch plate carries magnets, to heat the device, the method including the step of short circuiting the coils whilst they rotate relatively to the magnets whereby current flow is induced in the closed circuits of the coils, the magnetically induced forces being insufficient to engage the clutch.

### BRIEF DESCRIPTION OF THE DRAWINGS

For a better understanding of the present invention, and to show how the same may be carried into effect, the invention will now be described by way of non-limiting example, with reference to the accompanying drawings in which:

FIG. 1 is a perspective view of a pair of vehicle wheels, with a device according to the present invention fitted on a hub of the wheels;

FIG. 2 is a sectional view of the pair of wheels and the device of FIG. 1; and

FIG. 3 is a sectional view of the device of FIGS. 1 and 2 to a larger scale.

### DETAILED DESCRIPTION OF THE DRAWINGS

Referring to the drawings, a device according to the present invention is generally indicated by reference numeral 10 and is shown in its “in use” position in which it provides fluid in the form of compressed air to a rotating element in the form of a pneumatic tyre.

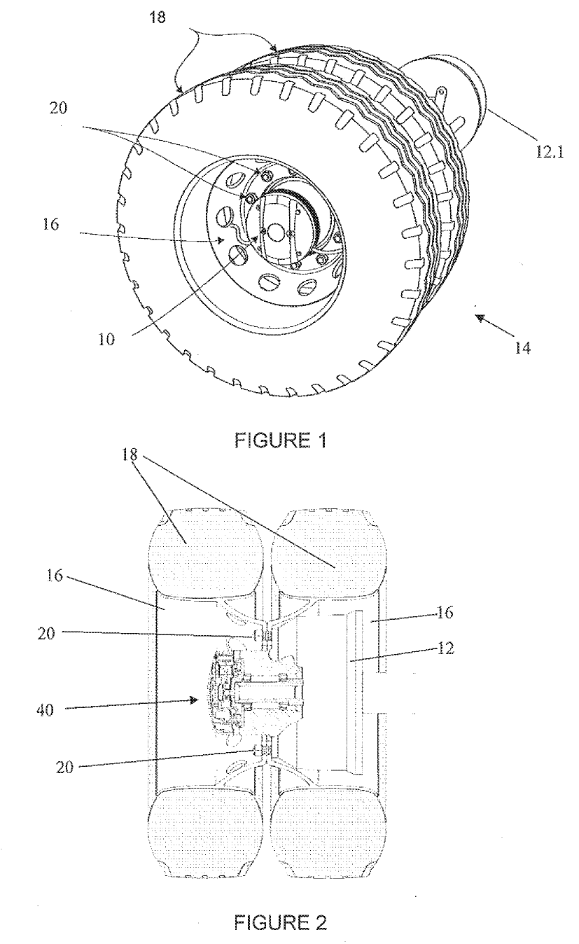

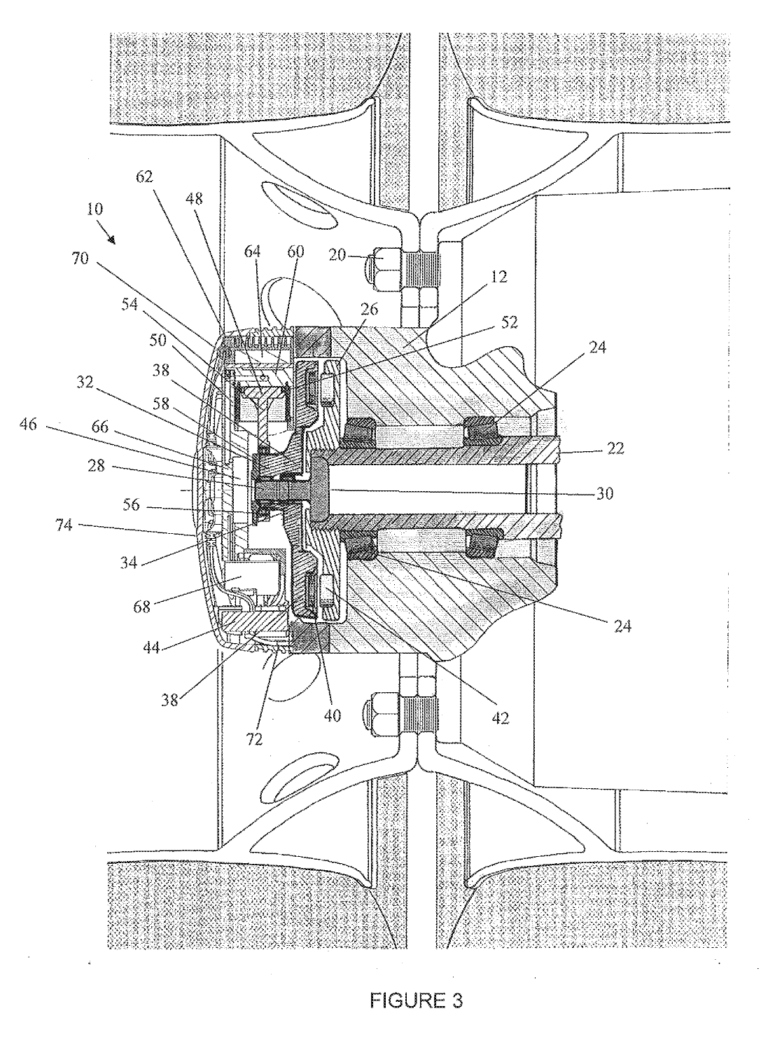

The device 10 is integrated into the hub 12 of a pair of wheels 14. Each wheel 14 comprises a rim 16 with a pneumatic tyre 18 on it, the rims 16 being attached to the hub 12 by wheel nuts 20. In the illustrated example, the wheels are not driven e.g. they are for a heavy vehicle trailer. In FIG. 1, another hub 12.1 is shown which shares a common stationary hollow axle 22 (FIGS. 2 and 3) with the hub 12.

Referring now to FIG. 3, the hub 12 is rotationally supported on the stationary hollow axle 22 by a pair of wheel bearings 24. The end of the axle 22 is threaded and a stator 26 is attached to its screw thread, thereby retaining the hub 12 and the wheel bearings 24 in place on the axle 22. In preferred embodiments, the stator 26 is attached to the axle 22 using additional attachment means, to keep it secure, ensure correct axial orientation, etc. By virtue of its attachment to the axle 22, the stator 26 does not rotate with the hub 12 and is thus a stationary object.

A pump axle 28 is located at the end of the axle 22 and a head 30 of the pump axle 28 is held in position in a recess at the end of the axle 22 by the stator 26. The pump axle 28 extends outwards relative to the wheels i.e. to the left as shown in FIGS. 2 and 3 from the stator 26 and remains stationary, with the axle 22 and the stator 26. An eccentric body 32 is supported on the pump axle 28 to rotate about the pump axle 28 on roller bearings 34. The body also forms a rotor 38.

A plurality of alternator coils 40 are carried by the rotor 38, on the same radius as a plurality of alternator magnets 42 that are carried by the stator 26. When the hub 12 and wheels 14 rotate, the rotor 38 rotates with them and movement of the alternator coils 40 in close proximity to the magnets 42 induces current in the coils, which is used to charge a battery pack 44 and provide power to electronics 46 of the device 10.

The device 10 further includes a pump piston 48 that can reciprocate in a pump cylinder sleeve 50 with a pump piston seal 52 sealing between the pump piston 48 and the sleeve 50. The piston 48 is connected to the eccentric body 32 by a connecting rod 54, running on a big end bearing 56 that is held in place by an eccentric bearing plate 58. A compression chamber is formed between the piston 48, sleeve 50 and a cylinder head 60 that includes an air filter 62 with a foam filter element 64. The piston 48, cylinder sleeve 50, seal 52, cylinder head 60, etc. form a pump that is configured to provide compressed air to the tyres 18. The connecting rod 54 of the pump piston 48 forms a first part of a pump drive system and the eccentric body 32 forms a second part of the pump drive system. The pump drive system is configured to activate the pump when pressure in a tyre 18 drops below a predetermined threshold, as will be described below.

A pressure manifold 66 defines a number of flow passages, connectors, etc. Three solenoid operated pneumatic valves 68, only one of which can be seen, are provided which are controlled by the electronics 46. The operation of the pressure manifold 66 is substantially as described in more detail in PCT/IB2013/054732 as will be evident from its functional description below. Suffice it to say that it defines a cavity and connects two tyre pressure hoses (from the two tyres 18), solenoid valves 68, two Schrader inflation valves and a pressure port from the compression chamber of the pump to a common cavity within the manifold.

Some of the ancillary features that are shown in FIG. 3 include an antenna 70 which allows the electronics 46 to communicate with external devices (e.g. with the vehicle's on-board computer); and wheel temperature and rotational speed sensors 72. Rotational speed is determined through a Hall effect sensor that senses rotation of a magnet attached to the stator 26. The parts of the device 10 on the outside of the rotor 42 (apart from the Schrader inflation valves) are protected by a cover 74.

In use, the entire device 10 normally rotates with the wheel hub 12, apart from the stator 26 and the pump axle 28.

When tyre pressure in a tyre drops below a predetermined pressure, direct current from the battery pack 44 is fed through the coils 40 to create an electromagnetic flux and the stator 26 (which is within the magnetic field created by the flux, is magnetised and resists rotation relative to the rotor 38 due to its specific hysteretic properties. The rotor 38, coils 40 and stator 26 thus act as a hysteresis powered electromagnetic clutch, except that the stator 26 acts as the hysteresis disc, whereas this function is conventionally fulfilled by a “rotor”. When the clutch is engaged, the rotor 38 and eccentric body 32 no longer rotate with the hub 12, but are held stationary, with the stator 26.

While the eccentric body 32 is held stationary by engagement of the electro magnetic clutch, the remainder of the device 10 continues its rotation and the relative rotation between the big end of the connecting rod 54 of the pump piston's and the eccentric body 32 causes the connecting rod 54 and the pump piston 48 to reciprocate within the pump's cylinder sleeve 50. The pump is thus activated and supplies compressed air that is directed via the pressure manifold 66 to the tyre 18.

When the tyre pressure reaches a predetermined level, the tyre is disconnected from the pump by the manifold 66 and current to the coils 40 ceases. The clutch disengages and the device 10 is returned to its normal state.

In the event that device 10 is exposed to extremely low temperature, e.g. if a vehicle on which it has been fitted has been stationary overnight and has been exposed to extremely low temperatures, the device 10 can be heated up by passing direct current through the coils 40 as described above, except that the current passed through the coils is too low to provide the force need to overcome resistance of the piston 48 to movement and thus does not engage the clutch. As a result, the rotor 38 continues to rotate relative to the stator 26, while the current in the coils 40 generates magnetic flux and the magnetic field generated also rotates with the rotor and coils. The stator 26 is stationary and thus in effect rotates relative to the magnetic field, while the flux passes through the stator. The relative movement of the stator 26 in the flux induces eddy currents in the stator, which generates opposing magnetic field (by operation of Lenz' law), which resists the rotation (albeit not enough to engage the clutch) and which converts the relative rotational motion of the stator to heat.

The heat generated in the stator 26 is transferred to the rest of the device 10 and once an acceptable operational temperature has been reached, the electric current supplied to the coils 40 ceases and the device returns to its normal operation.

In an alternative method of operation, instead of engaging the clutch by passing current from the battery pack 44 through the coils 40, the outputs of the coils are short-circuited, with the result that the rotation of the coils in proximity to the magnets 42 induces current in the closed circuits in the coils and this in turn generates a magnetic force opposing rotation and thus holds the rotor stationary relative to the stator. To release the clutch, the output from the coils 20 is simply opened.

Similarly, instead of passing current from the battery pack 44 through the coils 40 while continuing rotation of the rotor to heat the device 10, the output of the coils can be short-circuited intermittently (preferably using pulse-width modulation or “PWM”). Rotation of the coils 40 in proximity to the magnets 42 induces current in the closed circuits in the coils, which generates a magnetic force opposing the rotation. However, the periods (pulses) for which the coils 40 are short-circuited are short enough so that the magnetic forces induced are insufficient to overcome the resistance to movement of the piston. This holds the rotor stationary relative to the stator, so that the induced magnetic forces convert the relative rotational motion to heat.

What is claimed is:

1. A method of operating a device of the kind defined to heat the device which method includes the steps of rotating the clutch plates relatively to one another and supplying current to the coils which current generates a flux of insufficient magnitude to engage the clutch but of sufficient magnitude to generate eddy currents in the other clutch plate.

2. A method of operating a device of the kind defined, and in which the other clutch plate carries magnets, to heat the device, the method including the step of short circuiting the coils whilst they rotate relatively to the magnets whereby current flow is induced in the closed circuit of the coils, the magnetically induced forces being insufficient to engage the clutch.

3. A method as claimed in claim 2, wherein the coils are intermittently short circuited.

4. A method as claimed in claim 3, wherein the coils are short-circuited using pulse-width modulation.
